(19) United States
(12) Patent Application Publication
(10) Pub. No.: US 2001/0012286 A1
(43) Pub. Date: Aug. 9, 2001

(54) METHOD AND APPARATUS FOR COMPUTER ALERT OF DEVICE INDEPENDENT MESSAGES

(76) Inventors: EMMANUEL L. HUNA, DALY CITY, CA (US); KANG S. LIM, DANVILLE, CA (US); Stephen C. O'Neal, Corlorado Springs, CO (US)

Correspondence Address: JAMES W HUFFMAN, 1832 N. CASCADE AVE., COLORADO SPRINGS, CO, 80907-7449, US

(21) Appl. No.: 09/280,641

(22) Filed: Mar. 29, 1999

Related U.S. Application Data
(63) Continuation-in-part of application No. 09/240,435, filed on Jan. 29, 1999, now abandoned.

(51) Int. Cl. H04L 12/56

(52) U.S. Cl. 370/352; 370/401

(57) ABSTRACT

An apparatus and method for alerting a user upon receipt of selected messages, independent of the type of device generating the message is provided. Message generating devices include telephony devices (telephone, fax machine, etc.), or data devices such as a computer or PDA. All messages are converted into a format compatible with a data network for delivery to a web server. The web server includes a message notification system with message alert type selection and incoming message filtering. A user designates from a computer the types of messages for which s/he wishes to be alerted, and designates how the alert is to be presented on his/her computer. When messages are received by the web server, they are distinguished by message type, and filtered according to the user defined criteria. Selected messages cause a message indication to be generated provided to a program on the user's computer. The program alerts the user, either visually or audibly, depending on user defined criteria, of the number and type of received messages. One alert type of the present invention includes a flashing icon or LED on the user's computer system.

POP: point of presence, e.g., co-location at a local telco switch or at a company controlled area with Tl connections to a local switch

WPOP: Web POP

VPOP: Voice POP

### FIELD OF THE INVENTION

This invention relates in general to the fields of telephonic and data communication, and more specifically to a notification system for alerting a user (via a computer) of received messages, regardless of what type of device generated the message.

### BACKGROUND OF THE INVENTION

The advent of the telephone at the turn of the century presented a new form of communication to the population at large. Whereas prior messages were delivered directly to a message recipient by mail, telegraph, or personal courier, telephones introduced a new option for delivering a message. Urgent matters were treated immediately with a telephone message while less important matters were relegated to the mail. The option to call or write notwithstanding, a message originator still knew that the message itself was being delivered to a particular geographic location, presumably in the presence of a message recipient. One of the most elementary systems for delivering a message was known as a messaging service. To utilize such a service, the message originator selected message recipients and either wrote or dictated a message to an operator who, in turn, distributed the broadcast message serially to each message recipient over the telephony-centric network.

The advent of automated voicemail systems provided the means to take the human element out of the loop. Using a voicemail system, a message originator could record a message from his/her telephone and subsequently enter the telephone numbers of recipients for the message. The recipients of the message might be notified of the received voice mail by a flashing light embedded in his/her telephone. That is, if the recipient's telephone were so equipped, the telephone would indicate that a received voice mail was pending. If the telephone were not so equipped, the recipient would be required to call his/her voice mail system to determine whether any voice mails were pending.

Facsimile (fax) machines expanded the messaging options for a user. Now with a machine connected to the telephony-centric network, the user could convert a written page into electrical signals to be transmitted to a like machine over the telephony-centric network. The like machine would then translate the electrical signals back to text form and print out the transmitted page, thus delivering a textual message in a textual format. The recipient of a fax would be notified of the receipt of the fax by examination of the fax machine. That is, when a fax message was received, the fax would appear in the inbox of the fax machine. If the fax machine is part of a recipient's computer, the fax software on the computer might cause the computer to play a tone on the computer, or might cause a pop-up window to appear on the computer indicating that a fax had been received.

Though perhaps the most revolutionary series of events to advance the art of messaging has been the development of computer networking technologies resulting in what is now known as the Internet, along with related audio recording, storage, and transmission techniques. Today a user can access the Internet from virtually anywhere in the world and retrieve electronic mail (email). Notification of received email is typically provided to a recipient, either by causing a tone to be played on his/her computer, or by providing a pop-up window on the recipient's computer indicating receipt of an email. However, such notification presumes that the recipient's computer is directly connected to the internet, or automatically connects to the internet at predetermined intervals. If the computer is not directly connected to the internet, the recipient is required to dial in and establish a connection, just to determine whether an email message has been sent to him/her.

In spite of the above noted advances, several problems still exist. A first problem relates to restricted distribution of a message. More specifically, a message that is entered from a device connected to the telephony-centric network, i.e., a device having an assigned telephone number, is restricted for delivery to devices that are also connected to the telephony-centric network. A device with a telephone number is designed to distribute messages similar devices having telephone numbers.

Likewise, a message that is entered from a device connected to the Internet or similar data-centric network, i.e., a device having an assigned Internet Protocol (IP) address, is restricted for delivery to devices that are also connected to the Internet. A device with an IP address is designed to distribute messages to similar devices having IP addresses.

A second problem is that notification of received messages is based entirely on the type of device that receives the messages. As mentioned above, notification of voice messages may be provided by a flashing light, but only if the telephone is so equipped. Notification of received faxes requires the recipient to examine the inbox of the fax machine. Notification of received emails requires the recipient to examine his/her computer, and if not already connected to the internet, to dial a connection. Thus, notification of received messages is based on the type of message being sent, and the type of device that receives the message.

Therefore, what is needed is an apparatus and method for notifying a recipient of a received message that is independent of the type of message being sent (voice, fax, email, etc.).

Furthermore, what is needed is an apparatus and method for notifying a recipient of a received message that is independent of the type of receiving device for which the message was intended.

Furthermore, what is needed is an apparatus and method for alerting a recipient of a received message, that is independent of the type of message being sent, even when the message has been received by a remote messaging service.

### SUMMARY

An objective or goal of the present invention is to provide a user with an alert of received messages, irrespective of whether the type of device that sent the message communicated over a data network or a telephone network.

Another goal of the present invention is to provide a user with a configurable alert system, to allow him/her to be notified, either audibly or visually, at his/her computer, when their messaging system receives a fax, a voice mail, or an email.

Yet another goal of the present invention is to provide a user with an alert system that can filter received messages, whether voice, fax or email, and provide an alert to their computer based on the filtering.

To address the above-detailed deficiencies, the present invention provides a method for alerting a user of received messages transmitted from different device types, where the received messages are transmitted to a message notification system, and where the alert is provided to the user via a computer system. The method creates an indication of received messages, the indication prescribing the types of received messages, and the number of received messages according to type. The method then provides the indication of received messages to a program on the user's computer system. Finally, the method alerts the user of the received messages according to user configurable criteria provided to the program.

In another aspect, the present invention provides a message alert system including a computer system, a message notification system, and a computer program. The computer system includes a display screen. The message notification system is coupled to the computer system, and stores messages associated with different message types, and provides an indication of received messages to the computer system. The computer program is resident on the computer system, and communicates with the message notification system, and alerts a user of received messages. In one embodiment, the received messages originate from different device types. And, the alert is configurable by the user.

In yet another aspect, the present invention provides a message notification system, coupled to a data network, to receive messages originating from different message sending devices, and to notify a user via a computer upon receipt of selected ones of the received messages. The system includes a message notification system and a computer system. The message notification system, is coupled to the data network, to receive the messages, and to obtain the selected messages using user definable criteria, and to provide an indication of receipt of the selected ones of the messages. The computer system is coupled to the message notification system via the data network, and has a program for obtaining the indication of receipt from the message notification system. The program provides a configurable alert to the user corresponding to the indication.

### BRIEF DESCRIPTION OF THE DRAWINGS

These and other objects, features, and advantages of the present invention will become better understood with regard to the following description, and accompanying drawings where:

FIG. 1 is a block diagram of both a telephone network and a data network interconnecting end points between two cities.

FIG. 2 is a block diagram of a network independent communication channel according to the present invention.

FIG. 3 is a block diagram of a data network communication system according to the present invention.

FIG. 4 is a block diagram illustrating connection of remote point of presence (POP) servers with a network operations center (NOC), according to the present invention.

FIG. 5 is a block diagram illustrating data network initiated telephony according to the present invention.

FIG. 6 is a screen capture of a display interface of the ThinkLink service, according to the present invention.

FIG. 7 is a screen capture of a display interface illustrating the message alert features within the ThinkLink service.

FIG. 8 is a screen capture of a portion of a display illustrating additional message alert features within the ThinkLink service.

FIG. 9 is a screen capture illustrating alert filtering options embodied within the ThinkLink service.

FIG. 10 is a screen capture illustrating a filter summary of alert filters created within the ThinkLink service.

FIG. 11 is a flow chart illustrating the alert methodology embodied within the ThinkLink service.

FIG. 12 is a block diagram of a network according to the present invention illustrating device independent alerting according to the present invention.

FIG. 13 is a block diagram of a network according to the present invention illustrating the computer alert mechanism according to the present invention.

FIG. 14 is a flow chart illustrating the computer alert program according to the present invention.

### DETAILED DESCRIPTION

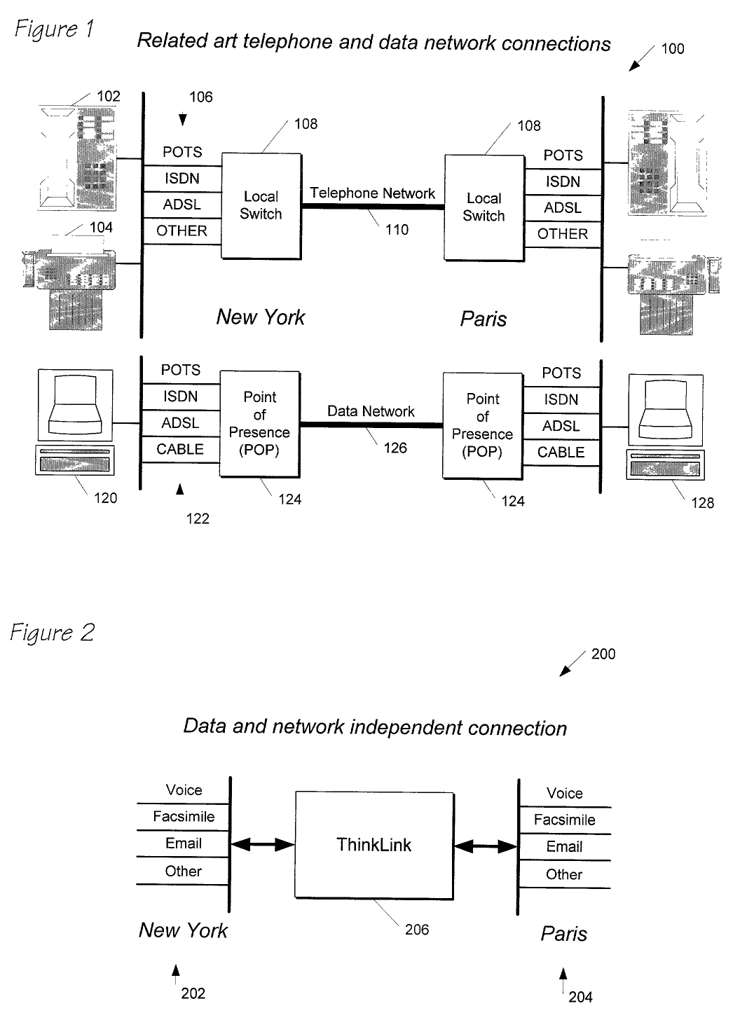

Referring to FIG. 1, a block diagram 100 is shown of a related art telephone network 110 and a related art data network 126. The telephone network 110 provides for transmission of communication between local switches 108, which are connected to telephony devices, such as a telephone 102 or a fax machine 104. One skilled in the art will appreciate that the telephone network 110 between the local switches 108 may consist of land lines (coax or fiber optic), line of sight microwave, or even satellite communications. However, from the local switch 108 to the end communication devices 102, 104, connections are typically made via a twisted pair, referred to as plain old telephone service (POTS). More recent communication channels from the local switch 108 provide for faster and cleaner transmission. These include Integrated Digital Service Network (ISDN) and Asynchronous Digital Subscriber Line (ADSL) technologies. These technologies, however, still communicate between essentially voice front ends, to a local switch 108, for access to the telephone network.

In operation, if an end user wishes to place a telephone call, s/he initiates the call using a telephone 102. The telephone 102 passes the telephone number to be called through the local switch 108, ultimately reaching a telephony device at the receiving end. At both ends of the call, communication is provided by the local switches 108. If the call is local, the caller is typically charged a single monthly fee and does not incur per minute charges for the time s/he spends on the telephone. However, if the caller that initiates the conversation is in say, New York, and the recipient of the call is in Paris, the caller that initiates the conversation is typically charged a long distance fee, from a long distance provider who either owns, or leases access to the telephone network 110.

If the type of information to be transferred is neither voice, nor fax, but is instead computer generated electronic information, communication between devices may be established over a data network 126. Examples of data networks 126 include local area networks (LAN's), wide area networks (WAN's), and the Internet. If the Data network is a LAN or a WAN, access to the network is typically provided via a hub or router (not shown) connected to one or more data servers (not shown). However, if the connection desired is outside of the LAN or WAN, communication is generally provided via typical telephone connections 122 (as above), coupled to a point of presence (POP) server 124. The POP server 124 is coupled to a data network 126, such as the Internet.

In operation, if a computer 120 wishes to communicate to a second computer 128, a connection between the computers 120, 128 is established via POP servers 124 over the data network 126.

While the telephone network 110, and the data network 126 are schematically shown in FIG. 1 with similarities, the type of information that is transmitted over the networks is very different. The telephone network 110 is optimized to carry primarily bi-directional voice communication (albeit digitized), while the data network 126 is optimized to transmit and receive computer data, asynchronously. The telephone network 110 does provide for transfer of information other than voice, but the devices that communicate over the telephone network 110, such as the fax machine 104, have been specifically designed to accommodate the essentially analog nature of the service.

In addition, when communicating from New York to Paris over the telephone network 110, a call initiator must contract for, and pay a long distance carrier for the privilege. In contrast, a computer user in New York can communicate with a computer in Paris, for example, without incurring any long distance charges. In fact, the only charges that will be incurred by computer user will be local telephone line charges to connect to his/her local POP 124. But, communication from the local POP 124 to any other POP 124 in the world is cost free to the user (depending on the user's contract rights with his/her internet service provider). This has made communication over the data network 126 very desirable. However, at present, the types of communication provided for via the data network 126 are predominantly for computer data (i.e., communication from computer to computer).

Also, while not shown in FIG. 1, it should be appreciated by one skilled in the art that calls from devices 102, 104 to other similar devices are not established unless the similar end devices are answered. Of more recent development are answering systems (not shown) connected to the telephone network to store particular message types, either voice or fax. In contrast, communication via email over data networks provides for message storing and retrieval without requiring two computers 120, 128 to be simultaneously connected to each other. Thus, data networks provide for asynchronous communication between computers, while telephony devices require some sort of answering device, or messaging service that is device specific. These answering devices typically require a user to call in to them to check to see whether any messages are pending. That is, voice messages and/or fax messages may be stored, either at the local switch 108, or at the user's location, but must be periodically checked by the user to determine whether messages have been received.

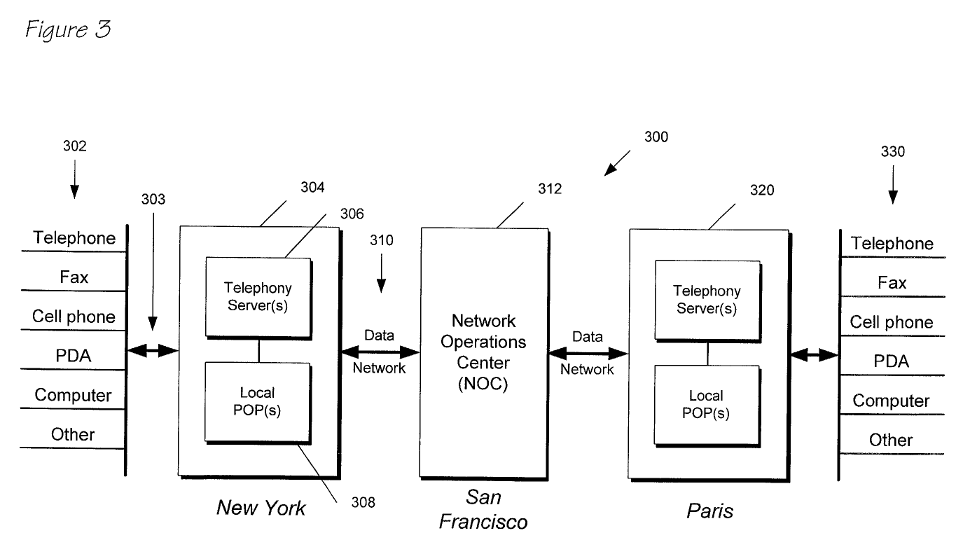

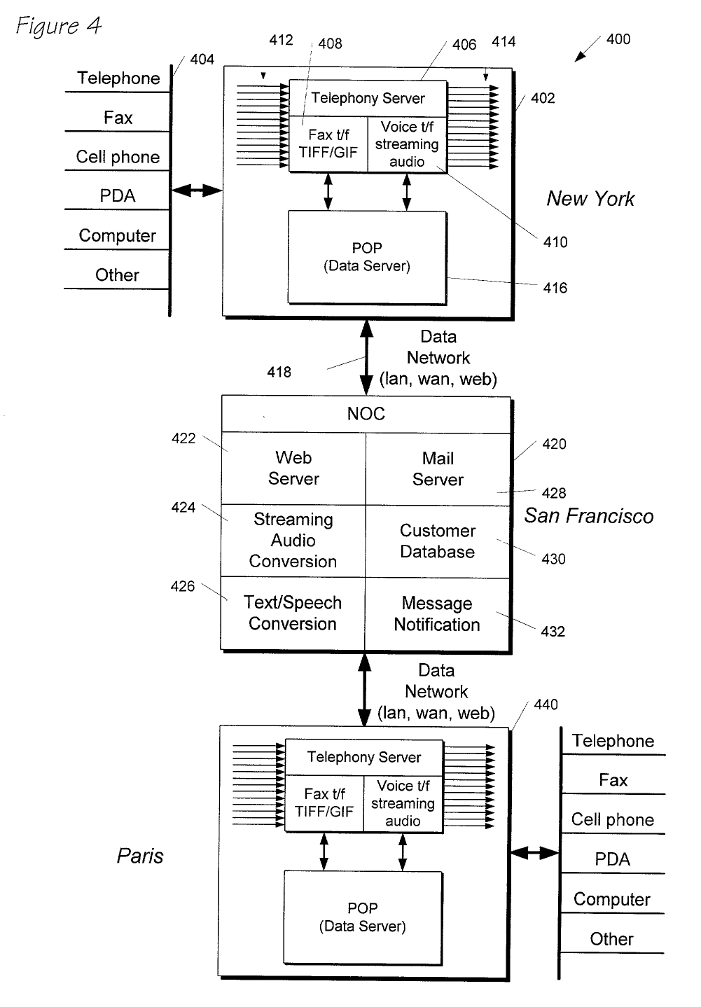

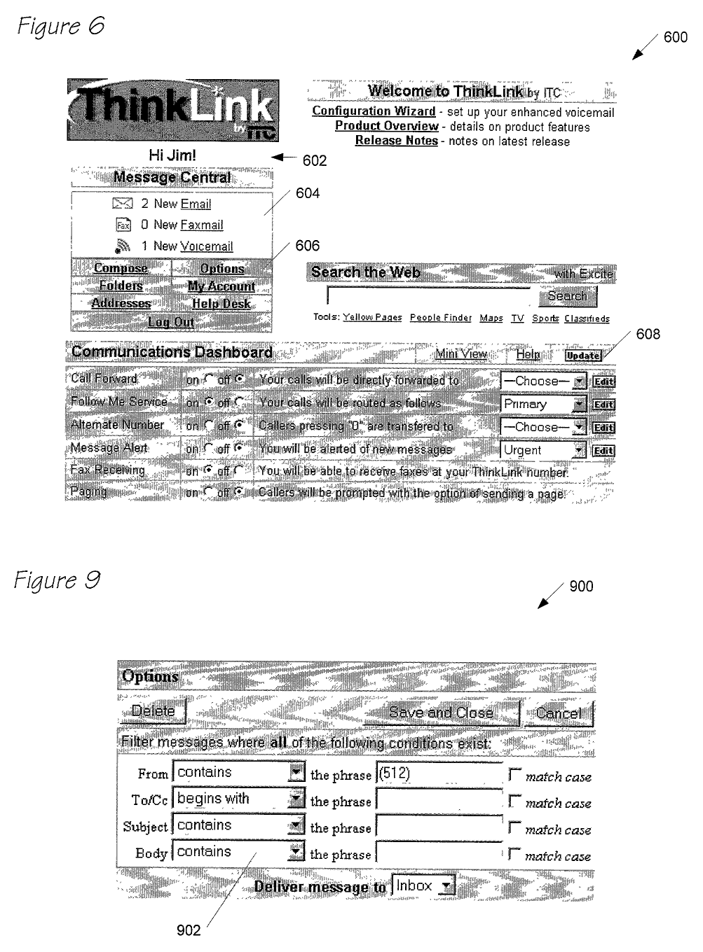

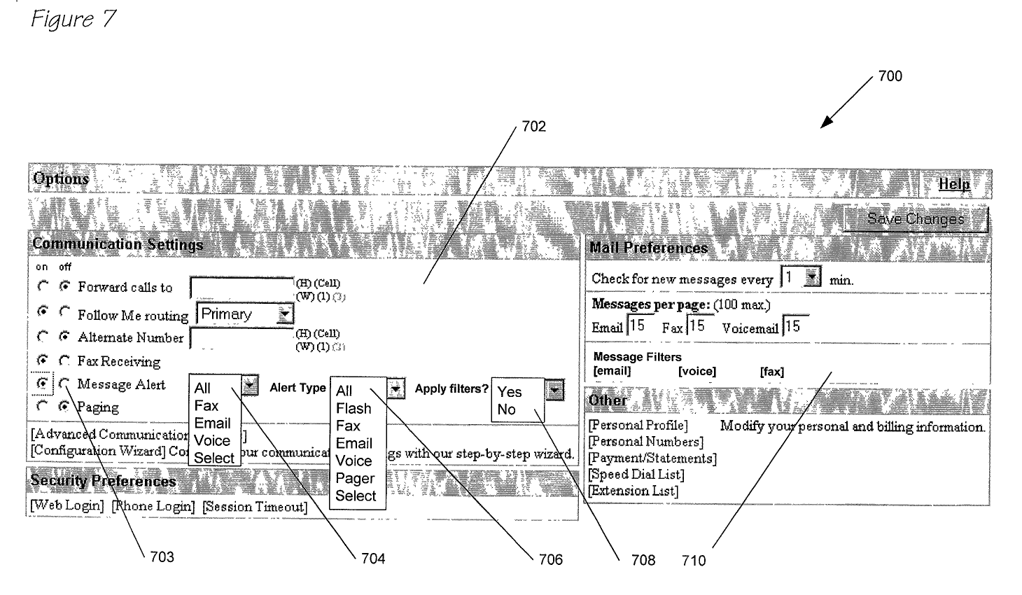

Referring now to FIG. 2, a block diagram 200 is shown illustrating the present invention which provides for communication between endpoints 202 and 204 that is essentially independent of either data type, or network type. Each end point 202, 204, say New York and Paris, may communicate with each other in any of a number of data types, such as voice, facsimile, email, or other analog or digital form, using end devices such as a telephone (analog or cell phone), fax machine, computer, personal digital assistant (PDA), or other device, via a ThinkLink interface 206. In addition, the device type at one endpoint 202 need not correspond to the device type at another endpoint 204. That is, the ThinkLink interface 206 allows bi-directional communication to be established between say a telephone and a computer. In addition, the ThinkLink interface 206 dynamically converts information into an appropriate format depending on how the user requests the information, regardless of the original format of the information. For example, if the information at one end of a connection is transmitted via email, and the user requests the email via a telephone, the email is dynamically converted to voice. Or, a user may wish to have faxes delivered via email, rather than to a physical fax machine. The ThinkLink interface 206 therefore not only connects all device types to a data network for delivery, but also provides conversion of differing data types, as specified by a user. This will be more particularly illustrated below with reference to FIG. 4. Furthermore, if an endpoint device does not answer, a messaging system within ThinkLink will store the message, regardless of message type, for later retrieval by a user. In addition, based on a user's configuration (defined in FIG. 7 below), ThinkLink will alert the user of received messages, regardless of whether the message is a voice mail, fax or email. The ThinkLink interface 206 is more particularly illustrated in FIG. 3, to which attention is now directed.

FIG. 3 provides a block diagram of the ThinkLink interface 300. More specifically, the block diagram 300 illustrates a number of different communication devices 302 coupled to a communications server 304 via modern voice or data connections 303. For example, the connection to the communications server 302 from the communication devices 302 could be POTS, ISDN, ADSL, cable modem, LAN or WAN. The communication devices 302 include telephone, fax, cell phone, personal digital assistant (PDA), computer, or any other telephony or data device compatible with existing or future telephone or data networks. The communications server 304 is then coupled to a network operations center (NOC) 312 via a data network 310. A second communications server 320 is shown connected to the NOC 312 via a data network to illustrate connectivity between the devices 302 and other remote devices 330. One skilled in the art will appreciate that while only two server connections are shown to the NOC 312, many other connections are provided. In fact, the number of data connections provided by the NOC 312 is essentially without limit, albeit concurrent connections may be limited by the bandwidth of the data network 310.

Within the communications server 304 are a telephony server 306 and a data server, or local POP 308. The telephony server 306 and the data server 308 may be provided by a single computer executing two applications (telephony and data), or in the alternative, may be two or more distinct computers executing their own applications (telephony and data). In fact, the configuration of the telephony and data servers 304, 306 may very from location to location depending on the number of communication devices requiring access to the communications server 304.

In operation, communication devices 302 that typically communicate over existing telephone networks (telephone, fax, etc.) connect to the communications server 304 via the telephony server 306. Other devices 302 that communicate over an existing LAN, WAN, etc., may communicate directly to the data server 308. However, once a communication device 302 connects to a local communications server 304, whatever the type of communication (voice, fax or data), all communication is routed over the data network 310 through a network operations center 312 in the form of Internet data. For example, if a user in New York using a voice capable computer wished to call a telephone in Paris, a connection between his computer 302 and his local data server 308 would be established. The call would be routed through a NOC 312, in San Francisco for example, and then over the data network to a local communications server in Paris. A call would then be placed by the telephony server in Paris to the telephone in that city. Voice communication would then be established over the data network 310, through the NOC 312, from New York to Paris. One skilled in the art should appreciate that this voice connection, established over the data network 310, is essentially cost free in terms of long distance charges to the user by a telephone company, presuming the user has established access to the data network, via an Internet service provider, for example.

Referring now to FIG. 4, a more detailed block diagram of a ThinkLink interface 400 is shown. The diagram 400 illustrates a number of different communication devices 404 connected to a communications server 402. The communications server 402 is coupled to a NOC 420 via a data network 418. The NOC 420 is also connected to other communications servers 440 via the data network 418. Within each communications server 402 are a telephony server 406 and a data server 416. The telephony server 406 is connected to typical phone connections (i.e., twisted pair, coax, T1, etc.) to provide connection between the communication server 402 and communication devices 404 that typically communicate over a telephone network. Such devices include telephones, fax machines, cell phones, etc. In one embodiment, a telephony server 406 is coupled to 2 T1 lines providing access to 48 phone lines, for inbound 412 or outbound 414 communication. These 48 phone lines may be dedicated to voice, fax, pager, etc., or may be dynamically allocated as demand varies. Within the telephony server 406 are two conversion applications: a Fax to/from TIFF/GIF converter 408, and a voice to and from streaming audio converter 410. The Fax converter 408 is capable of taking a fax that has been received by the telephony server 406, and convert the fax images into either TIFF or GIF format, for transmission over the data network 418. In addition the fax converter 408 can receive text formatted files from the data network 418 and convert them into a fax format for transmission by the telephony server 406 to a fax device 404.

The voice converter 410 converts voice information received from the telephony server 406 into digital format (streaming audio or another audio format such as VOIP (H.323) for transmission over the data network 418. In addition, digital audio received from the data network 418 is converted into voice format for delivery by the telephony server 406 to a voice capable device 404 (such as a telephone or voice capable computer).

By using the fax converter 408 and the streaming audio converter 410, the telephony server 406 provides bi-directional transmission of information between typical telephony devices 404 and other remote devices accessible via a data network 418 (such as a LAN, WAN or Internet).

The NOC 420 contains a web server 422, a streaming audio converter 424, a text/speech converter 426, a mail server 428, a customer database 430, and message notification 432. Each of these will be discussed in greater detail below.

The web server 422 provides a front end interface for a user with a data connection to the NOC 420. The web server 422 allows a user to configure and control telephony and data connections from any device capable of accessing the Internet (such as a computer, a set top box, etc.). Examples of such controls will be discussed below with reference to FIGS. 6-9.

The streaming audio converter 424 provides a user with the ability to convert data received in digital audio format into other formats that s/he prefers. One example would be Real Audio format. The audio converter 424 has the ability to convert analog voice data received from the public switch telephone network (PSTN) into digital voice data. Voice data intended for delivery over a data network is typically converted to H.323 format; voice data being stored for later retrieval is typically converted to VOX format. Once the data is digitized, it can then be manipulated into alternate formats depending on the delivery/retrieval method. Thus, if a user desired to receive voice information in the form of Real Audio sent to his/her computer, the streaming audio converter 424 would convert the information to Real Audio format prior to delivering it to the user's local communications server 402.

The text/speech converter 426 provides the ability to convert text, such as email, into digital audio format, or audio format into text. Operationally, this allows a user to have email converted to voice information for delivery to a telephone, for example. Alternatively, information transmitted by a user in the form of voice, and ultimately digital audio format, could be converted to text for delivery as an email.

The mail server 428 provides an email interface for a user to send/receive email, either from an account established on the NOC 420, or alternatively to poll another email account for maintenance by the NOC 420. For example, a user may have an email account on the NOC at address joe@thinklink.com. In addition, the user may have another email account as joe@isp.com. The mail server 420 provides the user with the ability to receive all joe@thinklink.com email, and can also poll an external server to obtain mail delivered to joe@isp.com.

In addition, the mail server 428 is capable of storing messages that are either sent to a user, or created by the user. For example, the mail server 428 can store voice messages, fax messages, and/or email messages that have been sent to either telephone numbers, email addresses, or IP addresses associated with the user. The mail server can then deliver the messages in a format determined by the user (as defined in the customer database 430), according to predetermined criteria, as will be further described below.

The customer database 430 provides information within the NOC 420 regarding rules, address books, and other configuration information related to a particular user of ThinkLink. Such information will be described below with reference to FIG. 6.

The message notification 432 provides for message filtering, and alert notification of received messages, according to user defined criteria. Specifics of the message notification 432 will be provided below with reference to FIGS. 7-14.

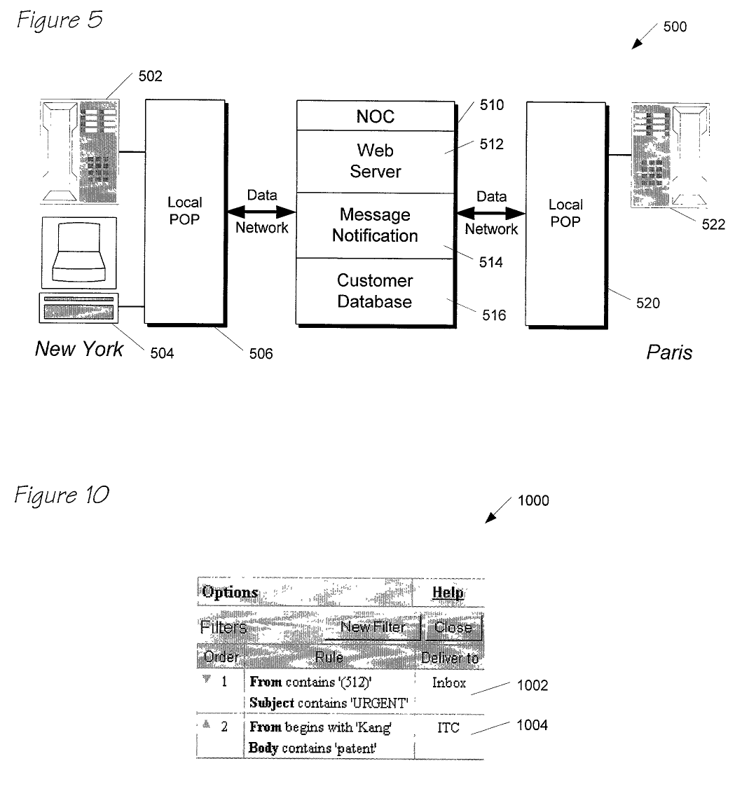

To recap, the ThinkLink interface 400 provides the ability to communicate between remote devices, that may create data in different formats (voice, fax, email, etc.), over a data network 418, without incurring long distance charges associated with the telephone network. In addition, the ThinkLink interface provides a user with the ability to communicate between remote end devices directly from the data network. Furthermore, ThinkLink allows a user to configure how messages are stored, and how they are delivered to him/her, regardless of the type of device that generated the message. And, ThinkLink allows a user to configure how s/he is notified of received messages, regardless of the type of device that generated the message. An example of this will now be described with reference to FIG. 5.

Referring to FIG. 5, a block diagram 500 is shown of communication devices 502, 504 and 522 connected via a ThinkLink interface. More specifically, a telephone 502 and a computer 504, located in New York, are connected to a local data server 506. The telephone 502 and the computer 504 may be connected to the local data server 506 over separate POTS lines, over a single ISDN line, or perhaps distinctly, such as by connecting the telephone 502 over a POTS line, and the computer 504 via a cable modem. The local server 506 is similar to that described above in FIG. 4. The local server 506 provides connection for the telephone 502 and the computer 504 to a NOC 510, and thus to any other communication device, via the data network.

The NOC 510 contains a web server 512, message notification 514, and a customer database 516. Other elements of the NOC 510 have been left out of FIG. 5 for ease of discussion. Operationally, if a user at a computer 504 in New York wished to establish voice to voice communication between his/her telephone 502, and a telephone 522 in Paris, the following sequence would occur. The user would select the two telephone numbers to be dialed, one associated with the telephone 502, the other associated with the telephone 522. The user selects these numbers from a customer database 516 via connection to the NOC 510 from his/her computer 504, or enters the numbers directly. Once the numbers are selected or input, the user initiates the call. The NOC 510 establishes a data connection with the local server 520 in Paris and the local server 506 in New York in one of two ways. First, the NOC 510 may instruct the New York POP 506 to dial the local New York number. Once the local connection is established, the New York POP 506 directly dials the Paris number. Or second, the NOC 510 may instruct the New York POP 506 to dial the local New York number. Once the local connection is established, the New York POP 506 sends a request to the Paris POP 520 to dial the local Paris number. Once both local connections are established, the New York and Paris POP's 506, 520 communicate the voice data between each other using standard voice over Internet Protocols (e.g., H.323). More specifically, the voice information provided by each telephone 522 is converted into digital audio, transmitted over the data network to the other data server, converted back to voice format, and provided to the end device. In this scenario, the telephone conversation was initiated by the computer 504, over a data network.

An alternate example would be the following. A user in Paris could connect to their local POP from his/her telephone 522 and would select the address they wished to contact either by typing it in or by selecting it from an address list. The local POP would then connect to the computer and transfer data using standard voice over Internet protocols. If a user were sitting at the computer 504, a voice connection could be established with the user in Paris, via the data network.

In both of these examples, communication between end points is initiated and controlled by a server on a data network, rather than by a long distance telephone network. In addition, the type of the device initiating the communication is not restricted to telephony devices, but also extends to any device interfacing to the web server 512.

In both of these examples, it is possible that either of the end devices called by the NOC 510 do not answer. When this occurs, the message notification 514 allows a caller (whether the call is a telephone, fax machine, or email, for example) to leave a message. The message is stored within the message notification 514 for later retrieval by a user.

An exemplary interface to the web server 512 will now be described with reference to FIGS. 6-10 to which attention is now directed. FIG. 6 contains a screen shot 600 of the ThinkLink web interface. Access to the web server 512 may be provided by any device capable of connecting to the Internet. Such devices now include personal computers, PDA's and set top boxes, but others are anticipated in the future.

Once an account is established with ThinkLink, a user logs onto the web server 512. Note: an account typically provides a user with a telephone number, a fax number, and an email address. These contact numbers, and email address may then be provided to friends, family, clients, etc., to reach the user. If the user is not available, messages, in the form of voicemail, fax or email may be left with the web server 512.

When a user logs onto the web server 512, the server 512 queries the database and returns to the user an HTML page that indicates the type (voicemail, fax, email) and number of unviewed messages the user has in the system. If the user wishes to examine new messages, s/he simply clicks on the corresponding hyperlink text, and is taken to a message area applicable to the message type. Alternatively, if a user calls in to their local POP, the POP queries the web server 512 and returns a series of menu prompts that indicate the type (voicemail, fax, email) and the number of unviewed messages the user has in the system. In FIG. 6, Jim is shown to have 2 new email messages, 1 new voice message, and 0 faxes.

Below the message control 604 are menu commands 606. These allow a user to configure ThinkLink to manage his/her account according to predefined criteria.

In addition, a communications dashboard 608 is provided. The communications dashboard 608 allows a user to configure how the telephony server is to act when receiving messages. For example, if a user receives a telephone call to his/her ThinkLink number, he can have it automatically forwarded to a different telephone. If the user is traveling, for example, upon arrival at each destination, the user could access his configuration, via a computer or a telephone, and could change his configuration to forward all calls to his new destination.

Alternatively, a user may wish for ThinkLink to record messages, either fax, email or voice, but may wish to be alerted at his/her computer, or via pager, email, fax, or telephone when particular messages arrive. This feature will now be particularly described, beginning with reference to FIG. 7.

Referring now to FIG. 7, a screen shot 700 is shown of communication settings accessed via the options link 606 on the screen 600. The screen 700 includes communication settings 702, message alert selection boxes 704, 706 and 708, and message filters 710. The communication settings 702 allow a user to selectively configure whether voice/fax calls are routed to alternative telephone numbers, and/or whether the calls are recorded within the message notification 514.

In addition, a message alert button 703 is provided to allow a user to selectively turn on/off a message alert feature of ThinkLink. More specifically, a user can turn on message alert via button 703. The user is then provided with drop down boxes 704, 706, 708 to configure when and how s/he is to be alerted. For example, drop down box 704 allows the user to select the types of messages for which s/he wishes to be alerted. These include all message types, faxes only, email only, voicemail only, or a select combination between these. One skilled in the art should appreciate that as new message types are developed, they can be included within the alert engine of the present invention. For example, if a user wished to be alerted any time s/he received a fax, s/he would select the fax option on drop down box 704.

Once message alert 703 is turned on, and a message type 704 is selected, the user can configure how s/he wishes to be alerted via drop down box 706. Drop down box 706 illustrates five alternative message alert types: flash, fax, email, voice, and pager, or any combination of these. For example, a user may wish to be paged upon receipt of any fax. The user would select fax in box 704, and pager in box 706. Then, upon receipt of any fax, message notification 514 would cause the user's pager to be called. Alternatively, upon receipt of a voice mail, the user may wish to have his/her computer “flash” a message on the screen (or play an alert through the computer speakers).

Furthermore, in addition to selectively enabling alert messages to be generated based on message type, filters may be used to further qualify or distinguish between received messages. Filter selection is made via drop down box 708. When filtering is turned on, a user is given the opportunity to enter filtering, based on message type, via box 710.

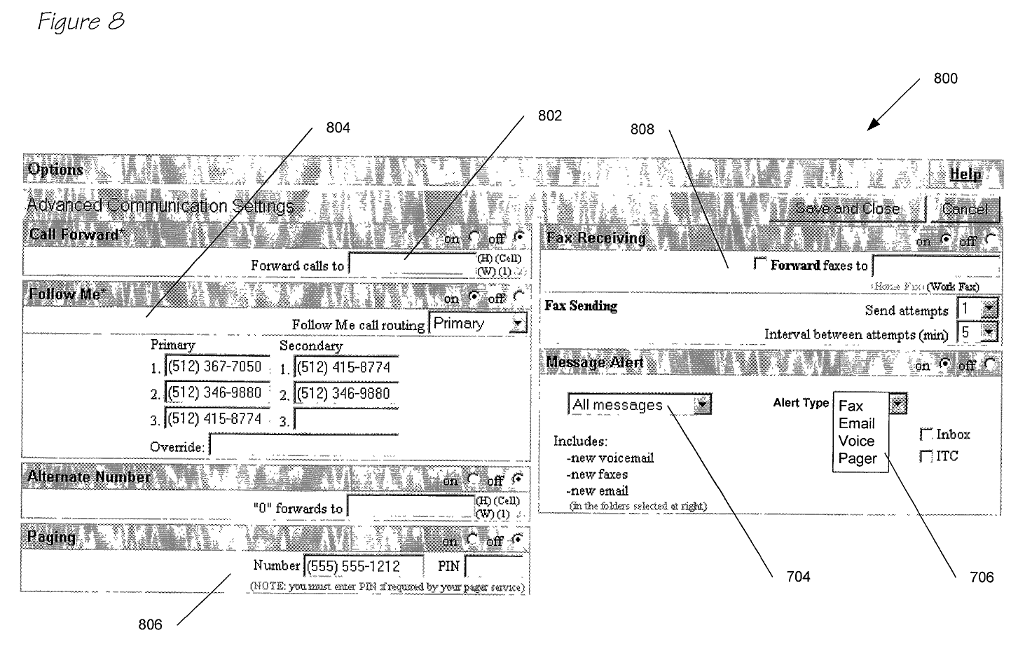

Referring now to FIG. 8, a screen shot 800 is shown which illustrates how a user enters specifics regarding the communication settings selected in box 702 of FIG. 7. More specifically, telephone numbers for call forwarding are entered in box 802. Telephone numbers for follow me routing are entered into box 804. A pager number (and PIN) are entered into box 806. Fax forwarding numbers are entered into box 808. In addition, the selection boxes 704 and 706 are repeated in screen 800 for ease of use.

Referring now to FIG. 9, a screen shot 900 is shown of the filtering options accessed via the selection box 710. The screen 900 is shown for email and voice mail message types, but a similar box may be provided for fax messages. Within the screen 900 are user definable criteria 902 for distinguishing between messages. For example, if the message type is voicemail (or fax), a user could specify a filter to select only those messages originating in area code 512. If such a designation is made, and filtering is turned on (via box 708), using the examples above with Reference to FIG. 7, a user would be alerted via his pager when a fax is received that originated from area code 512. Of course, other criteria is available for filtering such as who the message is being sent to, whether a message subject is available (for voice or email, for example), and whether the body of the message contains particular text (for email or fax, for example).

Referring now to FIG. 10, a screen capture 1000 is shown that summarizes filters that have been created for incoming messages. A first filter 1002 is created for voice mail originating in area code 512 that contains urgent within the subject box. A second filter 1004 is created for email with a sender's name of “Kang”, where the body of the email contains the word “patent”. Either or both of these filters may be applied to distinguish incoming messages for the purpose of alerting a user.

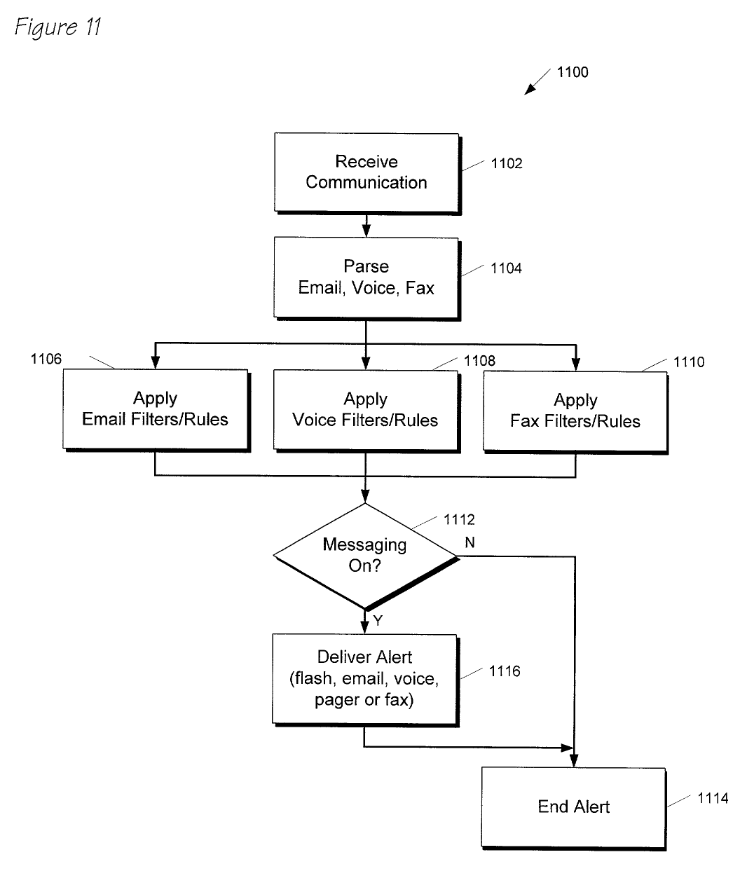

The above description of FIGS. 6-10 provide one embodiment for entering message alert options into ThinkLink. One skilled in the art will appreciate that it is not the interface that is important. Rather, it is that message alerts may be generated for one or more receiving devices, upon receipt of any message, voice, fax or email, based either on message type, or on further criteria established via filters applied to received messages. The methodology incorporated into the message notification 512 is particularly illustrated in FIG. 11, to which attention is now directed.

Referring to FIG. 11, a flow chart 1100 is provided to illustrate the message notification methodology incorporated within ThinkLink. Flow begins at block 1102 upon receipt of a communication (whether voice, fax or email), and proceeds to block 1104.

At block 1104, a determination is made as to whether the received message is an email, voicemail or fax. The message is then forwarded to one of the blocks 1106, 1108 or 1110.

At blocks 1106-1110, filters applicable to the message types are applied. Flow then proceeds to decision block 1112.

At decision block 1112 a determination is made as to whether messaging is turned on. If not, then message alert ends, at block 1114. Otherwise, flow proceeds to block 1116.

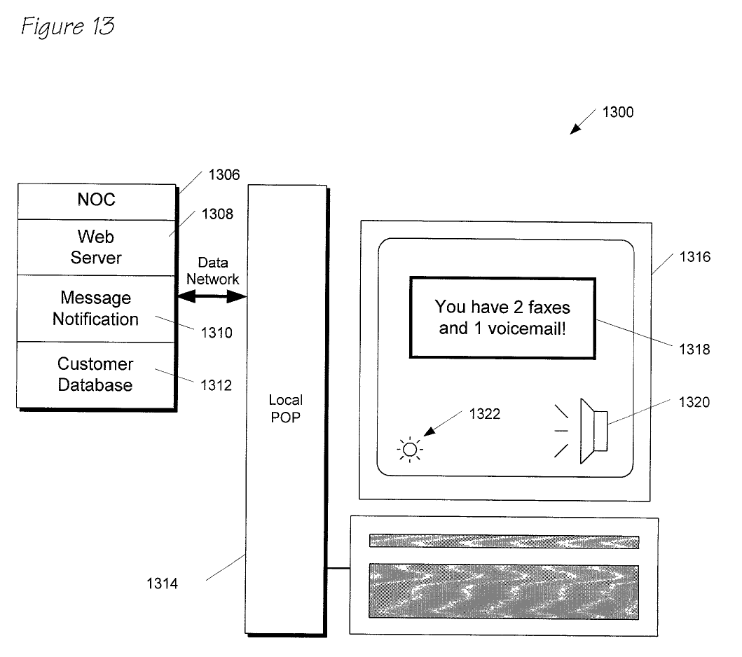

At block 1116, the user is alerted of the received (and filtered) message, according to criteria defined in FIG. 7. If the user has selected “flash” as the alert type, additional criteria may be provided to the user's computer, as described below with reference to FIG. 13.

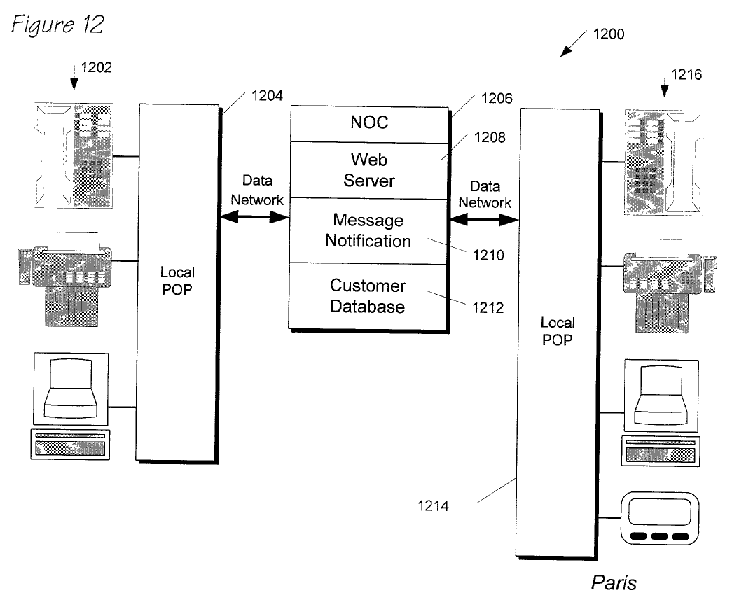

Referring to FIG. 12, a block diagram 1200 is shown, similar to that described above with reference to FIG. 5. The diagram 1200 includes a number of different calling devices 1202 connected to a local data server 1204 in New York, and a data server 1214 in Paris, for example. When a call is made from any of the devices 1202 (fax, phone or email), and the message notification 1210 receives the message, the message notification determines whether an alert is to be provided, and if so, to what messages. If an alert is to be provided the message notification determines how the alert is to be provided (flash, email, fax, pager, for example), and delivers the alert to the appropriate data server 1214. The receiving device specified by the user receives the alert to notify the user that a particular message, based on message type, or other criteria, has been received. The user can then connect to the ThinkLink web server 1208, either from a computer or telephone, and can retrieve the message.

Referring now to FIG. 13, a block diagram 1300 is provided that particularly illustrates the “flash” alert feature of the present invention. The diagram 1300 contains similar elements to those described above in FIG. 12, with the hundreds digits replaced by “13”. More specifically, a computer 1316 is shown attached to a data network via a local POP 1314. Message notification 1310, upon receipt of a message (either voice, fax or email, for example), if configured to alert the user via the “flash” alert type, will send a message to the computer 1316 indicating the type of message received. The flash alert may be initiated by the message notification 1310 if the computer 1316 has a dedicated IP address, for example. Alternatively, the computer 1316 may have a “bot” (an automated robot) program configured to poll the message notification 1310 at predefined intervals. In either case, the computer 1316 is periodically notified of received messages pending in the message notification block 1310 of the NOC 1306.

When the computer 1316 has been notified of pending messages, a program (not shown) on the computer 1316 is caused to execute to alert the user that messages have been received. In one embodiment, the program is a plug-in to a web browser such as Internet Explorer, or NetScape Navigator. In an alternative embodiment, the program is a standalone program that may be configured to always be open. In yet another embodiment, the program is a TSR loaded into memory. In any of these cases, the program allows the user to configure the form of the alert, as well as how the program obtains notification of received messages.

For example, the program can be configured to flash an alert window 1318 on the user's computer. Alternatively, the program can be configured to play a message through speakers 1320 attached to the computer 1316. The message could be either a single tone, or can actually play a textto-voice translation indicating the number and type of received messages. The program can be configured to present the alert (whether an alert window, or a message), just once, or to continue to present the alert at predefined intervals.

In another embodiment, the program can be configured to present a changing icon 1322, similar to a flashing LED, in a predefined area of the computer screen 1316. Such a flashing icon 1322 acts similar to the flashing LED on telephones that indicate voice messages. However, in this case, the flashing icon 1322 indicates received messages that are independent of the message type. That is, it indicates received voice messages, faxes, or emails, for example. Furthermore, it indicates messages that have been filtered according to user criteria, as described above with respect to FIG. 7.

One skilled in the art should appreciate that the program executing on the user's computer prescribes the way the program obtains the indication of received messages. In addition, it should be appreciated that the program is portable between computers. Thus, a user can easily download the program, via an internet connection, to any computer that s/he happens to be working on, and can configure the program to obtain the message indication. Thus, regardless of where the user happens to be working, as long as s/he has a computer connected to the Internet, s/he can configure that computer to notify him/her of messages received by the message notification system, regardless of whether the messages are email, fax or voice messages.

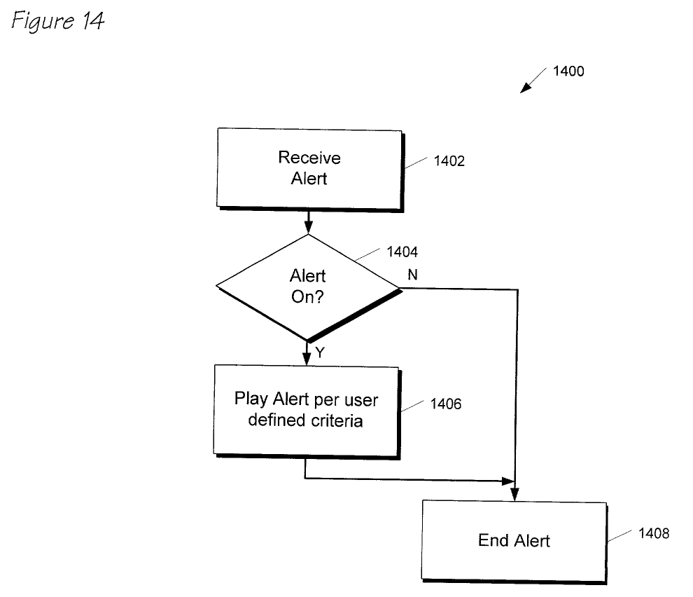

Referring now to FIG. 14, a flow chart 1400 is shown that illustrates the operation of the computer program described above in FIG. 13. Flow begins at block 1402 when the program receives an alert. As described above, the message alert is either sent from the message notification 1310, or alternatively, the program polls the message notification 1310 at predetermined intervals. Flow then proceeds to decision block 1404.

At decision block 1404, a determination is made as to whether the program has turned the message alert feature on. If not, flow proceeds to block 1408 where the message alert ends. If the message alert feature is turned on, flow proceeds to block 1406.

At block 1406, the program presents the message alert to the user according to the criteria described above. For example, the alert can be presented in the form of a pop-up window 1318, an audio message 1320, or a flashing LED 1322.

Although the present invention and its objects, features, and advantages have been described in detail, other embodiments are encompassed by the invention. For example, the discussion above with reference to FIGS. 612 illustrate message origination from telephones, faxes, or computers, and alert a user, based on message type and filtering, via pager, telephone, fax or email. Other communication options are possible for either incoming messages, or alerts. What is particularly novel is that a unified messaging system, with alert features is provided over a data network, without regard to the type of device generating the message, or the type of device with which the user desires to receive the alert.

In addition, the present invention is described using a configurable program on a user's computer that interfaces to a message notification system via a data network. The program is configurable, both in terms of how it communicates with the message notification system, and in the way that alerts are provided to the user. Other means of notifying the user via the computer are anticipated by the inventor. For example, the program may be user configurable to initiate its own subset of filtering criteria for received messages. In addition, the program may initiate other alert features such as notification by fax, email or pager, giving the user flexibility to configure alert criteria either within the message notification block 1310 at the NOC 1306, or remotely at his computer 1316.

Those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A method for alerting a user of received messages transmitted from a plurality of different device types, the received messages transmitted to a message notification system, the alert provided to the user via a computer system, the method comprising:
a) creating an indication of received messages, the indication prescribing the types of received messages, and the number of received messages according to type;
b) providing the indication of received messages to a program on the user's computer system; and
c) alerting the user of the received messages according to user configurable criteria provided to the program.

2. The method for alerting a user, as recited in claim 1, wherein the plurality of different device types comprise: a fax machine; a telephone; and a computer configured to send email.

3. The method for alerting a user, as recited in claim 1, wherein the indication of received messages is created by the message notification system.

4. The method for alerting a user, as recited in claim 1, wherein said indication is provided to the user's computer system via a data network connection between the message notification system and the user's computer system.

5. The method for alerting a user, as recited in claim 1, wherein said alerting comprises:
c1) flashing a blinking icon on the user's computer system.

6. The method for alerting a user, as recited in claim 1, wherein said alerting comprises:
c1) audibly presenting to the user a text to voice translation indicating the type of the received messages, and the number of the received messages according to type.

7. A message alert system comprising:
a computer system having a display screen;
a message notification system coupled to said computer system, for storing messages associated with a plurality of message types, and for providing an indication of received messages to said computer system; and
a program, resident on said computer system, for communicating with said message notification system, and for alerting a user of said received messages;
wherein said received messages originate from different device types; and
wherein said alerting is configurable by the user.

8. The message alert system as recited in claim 7 wherein said computer system is coupled to said message notification system via a local point of presence server.

9. The message alert system as recited in claim 7 wherein said plurality of message types stored by said message notification system comprise: faxes, voice mails, and emails.

10. The message alert system as recited in claim 9 wherein said indication of received messages indicates both the type of received messages, and the number of received messages, to said program.

11. The message alert system as recited in claim 7 wherein said program, upon receipt of said indication from said message notification system, presents a visual alert to the user via said display screen.

12. The message alert system as recited in claim 11 wherein said visual alert comprises:
a pop-up window; or
a flashing icon.

13. The message alert system as recited in claim 7 wherein said program, upon receipt of said indication from said message notification system, presents an audible alert to the user via said computer system.

14. The message alert system as recited in claim 13 wherein said audible alert indicates the number and the type of said received messages.

15. A message notification system, coupled to a data network, for receiving a plurality of messages originating from a plurality of different message sending devices, and for notifying a user via a computer upon receipt of selected ones of the plurality of received messages, the system comprising:
a message notification system, coupled to the data network, for receiving the plurality of messages, and for obtaining the selected ones of the plurality using user definable criteria, and for providing an indication of receipt of the selected ones of the plurality; and
a computer system, coupled to said message notification system via the data network, said computer system having a program for obtaining said indication of receipt from said message notification system, said program providing a configurable alert to the user corresponding to said indication.

16. The message notification system as recited in claim 15 wherein said plurality of different message sending devices comprise: a fax machine; a computer configured to send email; or a telephone.

17. The message notification system as recited in claim 15 wherein said indication comprises computer data, generated by said message notification system, indicating the number and type of said selected ones of the plurality.

18. The message notification system as recited in claim 17 wherein said indication is transmitted by said message notification system to said computer system via the data network.

19. The message notification system as recited in claim 17 wherein said indication is retrieved by said computer system from said message notification system.

20. The message notification system as recited in claim 15 wherein said configurable alert comprises:
a configurable visual alert; or
an audible alert.
